(19) United States
(12) Patent Application Publication
(10) Pub. No.: US 2013/0124362 A1
(43) Pub. Date: May 16, 2013

(54) SYSTEM, METHOD AND DEVICE FOR SHOPPING LIST GENERATION AND FULFILLMENT

(71) Applicant: Robert Katcher, San Jose, CA (US)

(72) Inventor: Robert Katcher, San Jose, CA (US)

(21) Appl. No.: 13/665,788

(22) Filed: Oct. 31, 2012

Related U.S. Application Data
(60) Provisional application No. 61/553,807, filed on Oct. 31, 2011.

(51) Int. Cl. G06Q 30/06

(52) U.S. Cl. CPC G06Q 30/0633
USPC 705/26.8

(57) ABSTRACT

A system and method for assisting user fulfillment by using a product input device is disclosed. The system includes a product input device that enables a user to input data and send the data to a server wirelessly. The server processes the received data in order to identify a product associated with the received data and provides a list to the user. The user's computing device is configured to receive the list and provide the list on a display of the computing device so that the user may interact with the list for fulfilling user needs.

### RELATED APPLICATIONS

This application claims the benefit of priority to Provisional Application Ser. No. 61/553,807, filed Oct. 31, 2011, titled SYSTEM, METHOD AND DEVICE FOR SHOPPING LIST GENERATION AND FULFILLMENT, which is incorporated herein by reference in its entirety.

### TECHNICAL FIELD

The disclosed embodiments relate to a system, method and device that enables a user to use a network enabled product input device to generate lists and assist in fulfilling user needs.

### BACKGROUND

Many individuals use a variety of different tools and methods for organizing different aspects of one's day to day life. Such methods include using calendars, budget sheets, to do lists, spreadsheets, etc., on one's own computing device (e.g., a PC, laptop, cell phone) or on physical paper (e.g., a post it or notepad). In particular, many people use shopping lists or grocery lists to assist in keeping track of what items are needed the next time they go to the store (e.g., ingredients for cooking, items for daily living, such as toiletries or clothing). However, current methods for using shopping lists to assist in fulfilling particular user needs have many deficiencies.

For example, users typically determine or realize what items they need while performing certain tasks—e.g., when performing tasks in the kitchen (such as cooking, baking, or cleaning), when cleaning (such as doing laundry or mopping), or when washing up (such as showering or using the restroom). In these situations, it is typical for the user to realize that some item is running low or out (e.g., a cooking ingredient, paper towels, shampoo). The user may want to remember the particular items and include them in a shopping list or grocery list. This requires the user to find his or her notepad in order to physically write down the items using a pen or pencil, or grab his or her computing device (e.g., a cell phone or tablet device), unlock the device, open up the program, and manually enter in the particular items needed.

Current solutions are also inefficient because family members may have only one copy of the shopping list or grocery list so that only one member can go to the store or shopping center to purchase the items on the list. Other disadvantages include the fact that if there are multiple copies of a shopping list, individual members may end up purchasing the same items multiple times. What is needed is a simple, quick, cost-effective and efficient system and method for creating, modifying and organizing shopping/grocery lists, reminder lists and checklists that anyone can use and that can easily fulfill a user's needs.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates a system for assisting user fulfillment by using a product input device, according to an embodiment;

FIG. 2 illustrates a method for initializing a wireless network configuration for a product input device by using a computing device, under an embodiment;

FIG. 3 illustrates a method for detecting and reordering batteries for a device, according to an embodiment;

FIG. 4 illustrates a method for providing fulfillment offers for a user, under an embodiment;

FIG. 5 illustrates a method for alerting a user to modify or organize a list, under an embodiment;

FIG. 6 illustrates a method for capturing data using a product input device, according to one or more embodiments;

FIG. 7 illustrates a method for changing a state of a product input device, under an embodiment; and

FIG. 8 illustrates a hardware diagram of a product input device, according to one or more embodiments.

### DETAILED DESCRIPTION

Embodiments described herein include a system, method and device for creating and maintaining shopping lists for a user. Using the list and the items provided on the list, the system may programmatically assist the user in fulfilling various user needs. According to some embodiments, the system generates entries for a shopping list by enabling the user to use a product input device and by processing data to provide an enhanced and improved user interface on the user's computing device. The product input device enables the user to input data corresponding to a product or item by scanning a code or by inputting audio data. The inputted data is listed as an entry on the user's shopping list. The user may interact with the user interface feature on his or her computing device to monitor and modify items on the list for purposes of shopping. The system may also automatically provide information regarding the user's fulfillment needs to vendors for quick and easy purchase and/or delivery of products or items to the user.

According to an embodiment, the system includes a product input device comprising an input mechanism, a scanning device, a microphone and a power source. The product input device may also include processing resources, memory resources and wireless communication resources. The product input device is configured to enable a user to perform a user action (e.g., press a button, move the device) via the input mechanism in order to cause the product input device to perform a sensing action. In some embodiments, the sensing action includes reading or detecting a code using the scanning device or receiving an audio input using the microphone. The system uses the data (e.g., data from the code or the audio input) in order to determine a corresponding product identifier and provide a user interface feature to the user's computing device.

Still further, the processing resource of the product input device can receive an initiation signal in response to a user action on the product input device. The initiation signal can be a trigger that causes the processing resource to activate a scanner and/or a microphone of the product input device concurrently. The product input device makes a determination that the scanner detected a product code or that the microphone detected an audio signal. Based on this determination, data corresponding to the detected product code or data corresponding to the detected audio signal can be wirelessly forwarded to a computing device, such as a server or a mobile computing device.

As an alternative or addition, once the product input device is initiated and detects a product code and/or an audio signal, the product input device can transmit data corresponding to the detected product code and/or data corresponding to the detected audio signal to a computing device or a server. The computing device or server can make a determination as to which data should be added or included to a user's list or account. For example, the server can detect a minimum output level of the detected audio signal or determine that only one of the detected code or audio signal is present. The server can also prioritize the data to detect the code first, for example, and if the code is not detected, to then process the audio (or vice versa).

In some embodiments, the system includes a server that is configured to wireless communicate with the product input device via a network. The server may receive data from the product input device and determine a product identifier based on the received data. The server determines the user's account that corresponds to the product input device used by the user and generates list data for the user that includes the product identifier. The server may provide the list data to the user's computing device so that the user may interact with a list (e.g., a user interface feature) based on the list data on the computing device.

According to one or more embodiments, the system monitors changes made to the user's list in order to assist the user in fulfilling various needs. In some embodiments, the system programmatically communicates information about the user's list and/or products or items on the user's list to merchant sources, vendors, retailers, or outside vendors in order to provide options, offers and prompts to the user efficiently.

Among other benefits, embodiments enable the user to quickly and easily create, modify and organize lists, reminder lists and/or checklists in order to efficiently fulfill the user's needs.

One or more embodiments described herein provide that methods, techniques and actions performed by a computing device are performed programmatically, or as a computer-implemented method. Programmatically, as used herein, means through the use of code, or computer-executable instructions. A programmatically performed step may or may not be automatic.

One or more embodiments described herein may be implemented using programmatic modules or components. A programmatic module or component may include a program, a sub-routine, a portion of a program, or a software component or a hardware component capable of performing one or more stated tasks or functions. As used herein, a module or component can exist on a hardware component independently of other modules/components, or a module/component can be a shared element or process of other modules/components, programs or machines. A module or component may reside on one machine, such as on a client or on a server, or alternatively a module/component may be distributed amongst multiple machines, such as on multiple clients or server machines. Any system described may be implemented in whole or in part on a server, or as part of a network service. Alternatively, a system such as described herein may be implemented on a local computing device or terminal, in whole or in part. In either case, implementation of the system provided for in this application may require use of memory, processors and network resources, including data ports, and signal lines (optical, electrical, etc.), unless stated otherwise.

Some embodiments described herein may generally require the use of computers, including processing and memory resources. For example, one or more embodiments described herein may be implemented, in whole or in part, on computing machines such as desktop computers, cellular phones, laptop computers, printers, digital picture frames, and tablet devices. Memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and PDAs), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

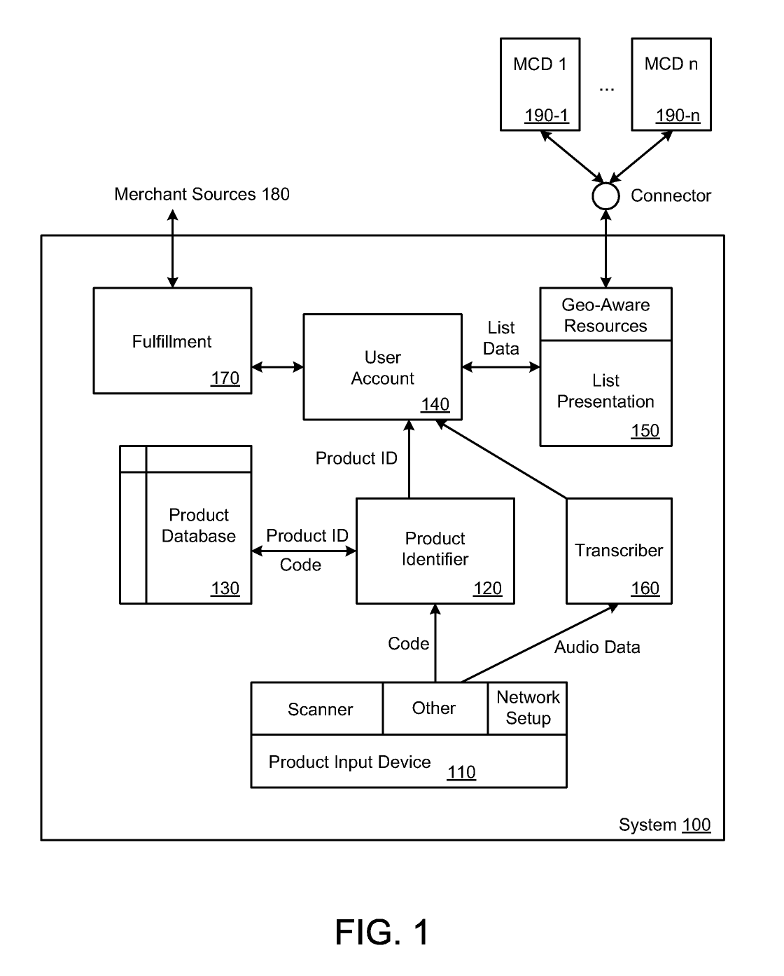

FIG. 1 illustrates a system for assisting user fulfillment by using a product input device, according to an embodiment. The various components described in system 100 may be implemented, in whole or in part, on a computing device(s), such as on a handheld device or a server. For simplicity purposes, the components shown in system 100 are illustrated as being separate from the product input device 110. However, various embodiments of the components described may be implemented, in whole or in part, on the product input device 110, one or more computing devices 190, or on a server. For example, in one embodiment, the product input device 110 may also include the product identifier 120 as well as the product database 130. In other embodiments, the product identifier 120 and the product database 130 may be provided as part of a server, for example. Depending on implementations, one or more (or all) of the components of system 100, such as the user account 140 or the list presentation 150, can be implemented on the user's mobile computing device 190-1.

System 100 includes a product input device 110. The product input device 110 is used by the user to input product data via a scanner and/or via a microphone for audio data. The product input device 110 enables a user to scan codes, such as UPC codes, of a product that he or she wants to purchase because it is running low or has run out. For example, when a user is cooking and uses the last stick of butter, the user may use the product input device 110 to scan the UPC code on the packaging box of the butter so that this item shows on the user's shopping or grocery list.

The product input device 110 comprises a scanning device, such as a 1-D or 2-D linear scanner, a laser scanner, or other optical scanner. The scanning device may be used to scan or read a code, such as a universal product code (UPC), an international article number (EAN), or other codes. The product input device 110 may also include other features such as a microphone, a speaker, light sources (e.g., LED light bulb), wireless communication components, and an input mechanism (e.g., a button(s)) that is used by a user to trigger certain actions or events on the product input device 110. For example, in one embodiment, a user my press down on a button and cause the scanning device to scan a UPC on a product or item. The product input device 110 also includes network setup for initiating wireless communication configurations (e.g., Wi-Fi, BT) for the product input device 110. In some embodiments, the network setup enables the user to wirelessly connect the product input device 110 to his or her home network so that data may be sent/received to/from a server(s) or cloud services via a network and/or the Internet.

According to some embodiments, a user may use the product input device 110 to read or scan a code, such as a UPC code on a product, via the scanning device. The user may want to do this in order to remind himself or herself to purchase this product the next time he or she goes to the store. System 100 may provide the scanned UPC code as a product name or identifier on a list for the user to see. The product input device 110 may also detect and/or store audio input from the microphone. The microphone may be activated for a period of time in response to a user action on the input mechanism (e.g., in response to a button press). In other examples, the product input device 110 may be button-less and display-less so that other triggers can be used to register an input to activate the scanner and/or the microphone (e.g., shaking the device to cause the accelerometer or gravitometer of the device register an input, holding the device or coming into close proximity to the device to cause the proximity sensor to register an input, waving a hand over an infrared sensor to register an input, etc.). The product input device 110 is configured to transmit the received data (i.e., data from scanning the code or audio data recorded from the microphone) and transmit it to either the product identifier 120 (for code) or a transcriber 160. In one embodiment, the product identifier 120 and/or the transcriber 160 may be provided on a server(s) in a network. In other embodiments, the product identifier 120 and/or the transcriber 160 may be provided on the product input device 110.

In one embodiment, the product identifier 120 wirelessly receives data corresponding to the code from the product input device 110. The product identifier 120 communicates with (e.g., searches, references, queries, etc.) the product database 130 in order to decode or determine the product ID (e.g., product name) that corresponds to the code data. The product database 130 may comprise and/or store a plurality of databases or tables that match different codes with product names and/or types. For example, the product database 130 may have multiple databases or tables that each correspond to different types of barcodes, such as linear barcodes (e.g., UPC, EAN, JAN, Telepen, Code ##) or matrix barcodes (e.g., 2D codes). Each code may correspond to an item or product.

For example, if the user scanned a UPC barcode for a particular box of cookies named “ABC Cookies,” the product identifier 120 receives the UPC barcode (or data corresponding to the UPC barcode) and programmatically searches the product database 130 to determine whether the UPC barcode is found. If the barcode is found, the product identifier 120 retrieves the corresponding product ID and transmits it to the user account 140. If the barcode is not found, the product identifier 120 transmits the code (e.g., the numbers representing the UPC) or other data to the user account 140. In this manner, the system 100 may be able to match the UPC barcode for “ABC Cookies” and provide it to a user's computing device, such as MCD 190-1, as part of a list (e.g., grocery or shopping list). In some embodiments, the product identifier 120 notifies the product input device 110 when a match is not made. The product input device 110 may make notify the user of the failed match (e.g., a buzz or sound or specific light color on an LED) so that the user may input the product by using the microphone to input audio data.

When the user inputs audio data via the microphone on the product input device 110, the product input device 110 may wirelessly transmit the audio data to the transcriber 160. According to an embodiment, the transcriber 160 receives the audio data and programmatically transcribes the audio data to make a written text corresponding to the audio data. For example, if the user spoke into the microphone and said, “bananas,” the microphone would detect/capture the audio input and transmit the audio data to the transcriber 160 so that “bananas” is sent to the user account 140. In this manner, the system 100 may be able to match the audio data for “bananas,” which was spoken by the user, and provide it to the user's computing device, such as MCD 190-1, as part of the user's grocery list. In some embodiments, as discussed above, the transcriber 160 may be provided with the product input device 110 so that the transcriber 160 transcribes the audio data at the product input device 110 and enables the data comprising the text, “bananas,” to be wirelessly transmitted from the product input device 110 to the user account 140.

In one example, if a scanned code is not found in the product database(s) 130, the product identifier 120 can prompt the user to provide audio via the microphone of the product input device 110. The product identifier 120 can instruct the user by providing a user interface feature on the user's mobile computing device 190 (via the user account 140 and the list presentation 150) and/or by causing the product input device 110 to output a notification sound (e.g., a “beep” sound or vibrate) that indicates to the user that audio needs to be assigned to the unmatched scanned code. When the user provides the input audio in response to the prompt or request, the audio signal can be transcribed by the transcriber 160, and the data corresponding to the transcribed audio signal (e.g., “macaroni and cheese”) can be programmatically associated or linked to the scanned code. The associated transcribed audio and scanned code can be stored in the product database(s) 130 for future reference for the user. In this manner, when the user scans that item again at a later time, the scanned code can have a corresponding product name associated with the scanned code.

The product input device 110 can also include a speaker, a light source (e.g., an LED), a vibrating mechanism, and/or other output devices to provide an alert or feedback to the user when the user operates the device. For example, when the user actuates the input mechanism to trigger the product input device 110 to activate the scanner and/or the microphone, a “beep” sound can be outputted by the speaker. In another example, a “beep” sound can be outputted when a scan of a barcode is detected and/or if a minimum audio threshold is satisfied (e.g., if the product input device 110 detects an audio signal). Similarly, another “beep” sound (e.g., a sound having a different tone, pitch, length of audio, or multiple “beeps” than the first “beep” sound) can be outputted if a barcode is not scanned or detected and/or if the minimum audio threshold is not satisfied.

In one embodiment, the user account 140 stores user information, such as user IDs and user preferences corresponding to a user's personal account. The user account 140 may match a user's account with the user's product input device 110 so that the product ID received from the product identifier 120 and/or the transcribed data received from the transcriber 160 is added to the user's own list. The user account 140 can also maintain information about the user's product input device 110 (e.g., the serial number of the device and its components, software or firmware version, etc.) as well as any preferences or configurations of the product input device 110 that is set by the user. If a user owns more than one product input device 110, the user account 140 may match the particular product input device 110 to a particular list. The user account 140 may store a plurality of different entries corresponding to received product IDs and/or codes and/or transcribed data, as well as other information, such as whether the received data corresponds to a new item or product or whether the received data has been received before. Other information stored, maintained and monitored by the user account 140 includes dates and times the user scanned (or recorded via microphone) a product, prices, priorities of which items are more urgent or are necessary compared to others, categories of items, and whether the list or portions of the list have been fulfilled by the system 100.

The user account 140 stores the entries received by a user's product input device 110 and provides the entries as list data to the list presentation 150. According to an embodiment, the list presentation 150 generates a user interface feature for presenting the identified products and/or code (e.g., if the product ID was not found in the product database) and/or transcribed data using the list data received from the user account 140. The user may access the user interface feature from his or her computing device in order to view his or her shopping list and interact with various features and items on the user interface feature. The list presentation 150 is coupled to a connector, which enables multiple computing devices 190-1, 190-n to wirelessly communicate with the list presentation 150 through a network (e.g., data can be exchanged between the system 100 and the computing devices 190-1, 190-n via the connector). In some embodiments, the list presentation 150 formats the user interface features for the different computing devices 190-1, 190-n so that the user interface feature is easily accessible and viewable from different types of computing devices. The user may also operate his or her computing device 190-1 in order to modify entries or preferences via the user interface feature.

In some embodiments, the list presentation 150 may programmatically generate a grocery list that includes items (either product IDs, codes, transcribed data) that the user has chosen to add to his or her grocery list. For example, the user may have scanned the code for two different items using the product input device 110 while doing his laundry—detergent, such as “Tide,” and fabric softener, such as “Bounce,” and may have spoken into the microphone “socks,” after deciding that he or she needed more socks. The user would be able to view on his or her computing device 190-1, such as a smart phone, a user interface feature showing a grocery list of the three items he or she had inputted:
1. Tide
2. Bounce
3. Socks
   The items may be listed in order of when the items were inputted, in alphabetical order, or in other different orders (random). In other examples, the list can be arranged in different categories (e.g., produce, frozen foods, kitchenware, etc.) so that items can be automatically categorized with one or more categories. The user may also interact with the user interface feature to reorder the list, prioritize certain items as being more important to purchase, mark or label certain items, check off items that have been purchased, delete items that he or she no longer needs, etc., so that the user has full control over his or her list. Changes to the list may be transmitted from the user's computing device 190-1 to the list presentation 150 of the system 100 via the connector(s). The list presentation 150 may cause the changes made to be reflected on the entries stored in the user account 140.

According to one or more embodiments, multiple users, such as members of a family or housemates, may typically share a grocery or shopping list, e.g., especially for items necessary around the home. Multiple users may share the product input device 110 so that all the items scanned or transcribed via audio data appear on one particular grocery or shopping list. In this manner, a user may operate a computing device, such as a mobile computing device (MCD) 190-1, to have access to the grocery list. The user of MCD 190-1 may go shopping and purchase an item on the list. The user may then check off the purchased, for example, from the list so that other users, such as the user of MCD 190-n may see the changes on the user interface feature provided on his or her MCD 190-n. Among many benefits, system 100 may help prevent a household or multiple users from purchasing the same item or product multiple times when using a grocery or shopping list.

In one embodiment, the list presentation 150 may include geo-aware resources for communicating with location aware detection means of a mobile computing device 190-1, 190-n. For example, the system 100 may enable certain features or perform tasks in response to detecting the location of the user via the user's mobile computing device (such as a smart phone). If the user is at a location that matches a store (e.g., a supermarket) for a predetermined amount of time, the geo-aware resources may map the position information from information received from the GPS of the user's smart phone, and determine that the user has gone shopping (or has left the supermarket after shopping). In other embodiments, the geo-aware resources may be a separate component that communicates with the user account 140.

In some embodiments, the system 100 also includes fulfillment 170. Fulfillment 170 communicates with the user account 140 to determine whether automatic fulfilling of user needs should be performed. According to implementations, the system 100 can communicate with or be a part of merchant sources. A merchant source, such as an online vendor, can receive product orders via the system 100 and automatically order one or more products for the user. Fulfillment 170 can communicate with the user account 140 that maintains user preferences for ordering products with a particular merchant source and also maintain list data corresponding to items that have been marked, via scanning or voice input, as being needed (e.g., needs to be purchased at a store) by a user. The user account 140 can also store one or more preferences for automatic ordering and delivering that have been configured or set by the user. For example, the preferences can be set so that the automatic ordering and/or delivering can be based on, for example, a set schedule (e.g., the products on the user's list are ordered every Monday and/or the products are delivered every Thursday) or after a certain threshold (e.g., products on the list are ordered when there is a threshold number of items and/or when the dollar amount of aggregate products on the list exceed a certain amount).

In another example, when the user goes to a store, such as a supermarket, to pick up certain items using the grocery list on his or her computing device, not every item may be found at that supermarket. In such cases, the user may mark off items that he or she has purchased, or mark items that he or she could not purchase or find, so that the system 100 may assist the user in fulfilling his or her needs. The user account 140 updates entries and data (e.g., new item, repeat item, dates, times, product names, prices, priorities, categories) via the list presentation 150, and provides information to fulfillment 170. Fulfillment 170 determines, at least in part from the information provided, what items should be purchased from other vendors 180 or what items are available at different merchant sources 180, and communicates this information back to the user account 140. Merchant sources may include online stores, such as Amazon or Overstock, and vendors where items are available both in-store and online, such as Costco, Walmart, Target, etc. The merchant information determined by fulfillment 170 may be provided to the user via the list presentation 150 so that the user interface feature provided on the user's computing device may provide options, notifications or prompts for the user to make a quick and easy purchasing decision.

The user can also maintain one or more lists that each correspond to different merchants or vendors. For example, the user can check items on a list to order each of the items from one or more vendors (e.g., online). After selecting one or more items to purchase, the user can order all the selected items for purchase. In order to make ordering easier for a user, the system 100 can pre-populate the check boxes (e.g., the box where the user makes a selection or checks the box) of the listed items as being checked. The user account 140 can communicate with the list presentation 150 to provide a list that automatically marks each of the items as being selected to order.

Fulfillment 170 may also enable automatic purchasing of an item or product upon determining that the item or product is needed. For example, the system 100 and/or one or more merchant sources 180 may store a user's credit card information and billing information, so that products deemed necessary by the user may be fulfilled if the user is unable to purchase it at a particular store or if the item is difficult to find. The user's financial information may be stored with the user account 140. In one embodiment, the user may also set his or her preferences or settings for system 100 so that not every item is automatically purchased or prompted for purchase by fulfillment 170. For example, via the user interface feature on the computing device, the user can (i) pick and choose which items should be purchased automatically by marking certain items in a distinguishing way, (ii) set a predetermined time period after a product or item has been on the shopping list before the system prompts or asks the user whether to purchase the item, (iii) require the user to enter a password before ordering a product, (iv) require a user to select “OK” or “purchase,” or (v) set other user preferences and/or options for controlling fulfillment 170 and the system 100 as a whole.

It can be beneficial to enable the user to configure the preferences for ordering and reordering products. In one example, a user can use the product input device 110 to scan a code for a product to be added to the user's list, and subsequently set a preference so that the scanned product (e.g., Crest toothpaste) can be purchased or ordered automatically (or at a set scheduled date or time, e.g., every week, every month, etc.). This general subscription of products, however, can sometimes result in over-ordering (or under-ordering) a product because the user has to guess the frequency of use. The user can be provided with another option of subscribing to a particular product(s). For example, with a “beep-to-buy” system (e.g., a single trigger purchase system), a user can scan a code of a particularly subscribed item or input the product name of the subscribed item via the microphone at any time. In this manner, this single trigger event (e.g., a single button press) can cause fulfillment 170 to instantly reorder the subscribed product (e.g., without having the user to wait until the next scheduled ordering cycle or delivery). In this manner, the user can set a preference(s) so that one or more products that the user scans via the single input event can cause the scanned product to be automatically ordered by a vendor of his or her choice (e.g., a selected vendor for a user stored with the user account 140).

Fulfillment 170 can also provide the user information and/or user's list to one or more merchants or retailers 180 so that the user can receive promotions, coupons, offers, or deals from the merchants or retailers 180 based on the user information and/or the user's list. For example, fulfillment 170 can provide information about items that the user has included in the user's list, items that have not yet been purchased, items that the user regularly orders, and/or the user's preferences or schedules for ordering certain products to the one or more merchant sources 180. Based on this information, the one or more merchant sources 180 can provide promotions, coupons, offers, or deals back to fulfillment 170 so that this information can be provided to the user (e.g., via the user account 140 and the list presentation 150). The list presentation 150, for example, can provide as part of the user interface a selectable feature (e.g., such as “Deals”) that the user can select in order to view what offers are being currently provided to the user.

As an example, the provided deal can correspond to a sale (at a lower value) for a particular product that the user regularly purchases or for a competitor product (e.g., a different manufacturer's product) that is similar to the product that the user regularly purchases. Deals can include a percentage off the cost or delivery fee, faster delivery, buy one get one free, etc., to persuade the user to order a certain product from the vendor.

By using the system 100, the user may easily and efficiently organize items or products that he or she wants to purchase, and system 100 may assist in fulfilling the user's needs.

Methodology

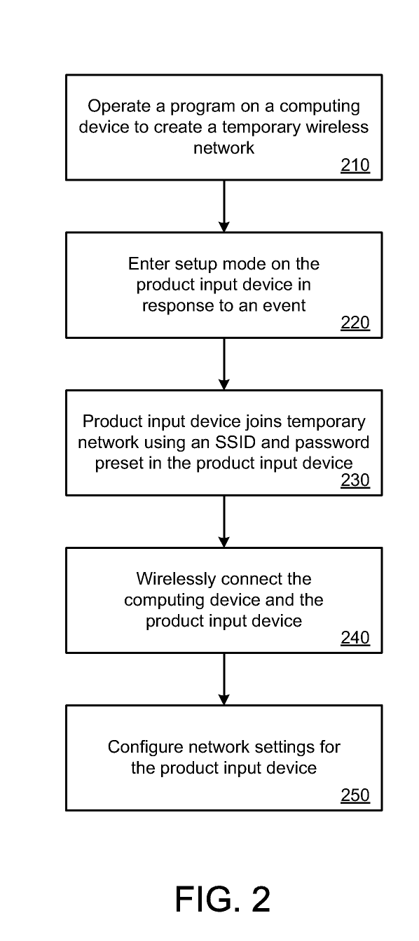

Methods such as described by an embodiment of FIGS. 2 through 7 may be implemented using, for example, components described in embodiments of FIG. 1. Accordingly, references made to elements of FIG. 1 are for purposes of illustrating a suitable element or component for performing a step or sub-step being described. FIG. 2 illustrates a method for initializing a wireless network configuration for a product input device by using a computing device, under an embodiment.

In some embodiments, the product input device 110 is a small, handheld device that includes a single button and lacks a display. For such devices, configuring the devices for network connectivity (e.g., Wi-Fi) may be difficult due to the lack of a keyboard and a display. FIG. 2 illustrates a method for an initial Wi-Fi configuration for the product input device 110 using a computing device that has a display and/or a keyboard. In FIG. 2, a user launches and/or operates a program (e.g., such as a network set up wizard program) on a computing device to create a temporary wireless network between the computing device and the product input device 110 (step 210). The computing device may be a personal computer, a laptop, a tablet device, a smart phone, e.g., that is in control by the user of the network (e.g., the user's home network). The computing device may be the computing device described in FIG. 1, such as MCD 190-1, 190-n, or another computing device. The computing device has a display and/or input mechanisms such as a full keyboard and/or a mouse and/or track ball (i.e., a user friendly input mechanism) so that the user can easily access the program running on the computing device.

The user can then enter a setup mode on the product input device 110 (step 220). The setup mode can be entered into in response to an event. According to one or more embodiments, the event may be a user action on the product input device 110 itself, such as by performing an action on the input mechanism of the product input device 110 (e.g., a button press, a swipe or tap on a touch panel), by moving the product input device 110 in a particular manner (e.g., shaking the device causes the accelerometer or gravitometer of the device to register an input), by speaking into the microphone, or by scanning an item using the scanning device. The event is a trigger that causes the product input device 110 to enter into the setup mode.

Once the product input device 110 enters the setup mode, the product input device 110 may join the temporary wireless network with the computing device by using an SSID and/or password that is preset and/or stored in the product input device 110 (step 230). The SSID can be tied to a serial number and/or another unique device identifier, or could be a generic number. The password may be preconfigured and easily determined by the user (e.g., comes with the manual or packaging box of the product input device 110). In other embodiments, the password may be more secure, so that the user must scan a code or a randomly generated password using the product input device 110.

By using the SSID and password, in some embodiments, the computing device may wirelessly connect to the product input device 110 (step 240). The product input device 110 may then be configured manually using the program on the computing device or may be configured automatically in order to configure the network settings (step 250). According to an embodiment, a plurality of different networks may be added to or configured with the product input device 110.

In other embodiments, other wireless protocols may be used to set up the product input device 110 to be configured to a user's network, such as Bluetooth protocol. The product input device 110 may use a Bluetooth file exchange, for example, to have a file pushed to it from the computing device that includes the network configuration settings. According to other embodiments, because the product input device 110 includes a microphone and/or a transcribing mechanism, the network configuration may be performed through voice recognition. Among many benefits, such a method implemented by FIG. 2 may help keep costs to a minimum because no additional connectors (e.g., such as a USB port) or additional radio communication ports are needed for the product input device 110.

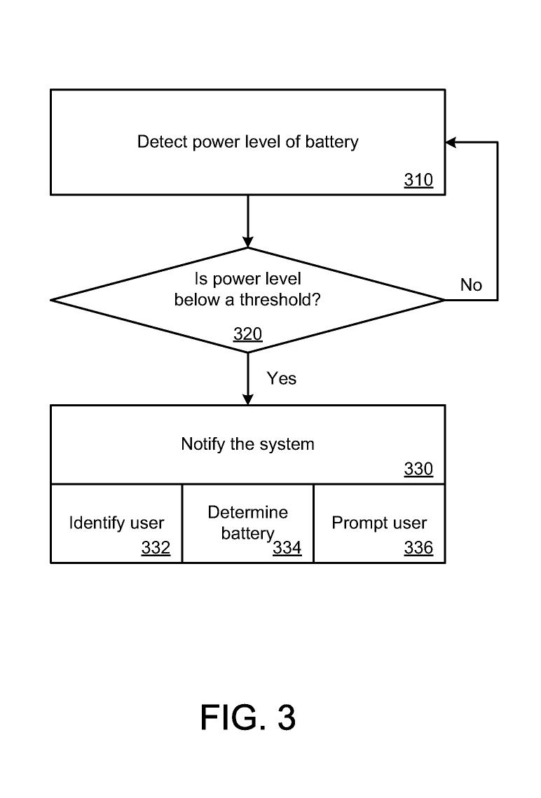

FIG. 3 illustrates a method for detecting and reordering batteries for a device, according to an embodiment. As discussed with respect to FIG. 1, system 100 is used to assist a user to efficiently fulfill the user's various shopping and/or grocery needs. The user uses the product input device 110 to keep track of items or products that he or she needs to purchase the next time he or she makes a trip to the store or supermarket. In FIG. 3, the product input device 110 also assists the user in fulfilling needs by automatically detecting its power level, e.g., the power/energy level of its disposable battery, and reordering the battery or listing/including the battery in the user's grocery or shopping list.

In FIG. 3, the product input device 110 detects or monitors the voltage level or power level of its disposable battery (step 310). For example, the product input device 110 may operate using a single or multiple batteries of different sizes, such as AA, AAA, D, 9-Volt, button/coin/watch/micro cells, and different brands, such as Duracell, Energizer, or generic brands. The product input device 110 includes processing resources that are able to interact and communicate with other components, such as a voltage detection mechanism, to monitor how much battery life is available in the current battery.

As the power or voltage level of the battery is monitored, the product input device 110 determines whether the power or voltage level of the battery is below a predetermined threshold (step 320). If the power or voltage level is not below the predetermined threshold, the processing resource continues to monitor the power or voltage level (e.g., return to step 310). In some embodiments, the threshold may be configured or set (e.g., 20% of battery level) by the user according to his or her preference. For example, the user may want the product input device 110 to order itself a new battery a few days in advance in case the next 20% of the battery level may be used while the battery is being delivered. If the power or voltage level is detected to be below the predetermined threshold, the method moves to step 330.

According to one or more embodiments, once the processing resource of the product input device 110 determines that the power level of its battery is below a predetermined threshold, the product input device 110 notifies the system 100 that its battery is low (step 330). As an alternative or addition, the product input device 110 may notify the system 100 the user (e.g., by sending an identification of the product input device 110 to identify the user(s) who is using this device) so that the proper user(s) may order and/or receive the replacement battery (step 332). In some embodiments, once the product input device 110 determines that a new battery is needed because its current battery level or power level is low, the product input device 110 transmit data representing the battery to the product identifier 120 (e.g., as if the user had manually scanned a code of the battery or had spoken into the microphone “battery”). In this way, the product identifier 120 can communicate the product ID to the user account 140. The user account 140 can identify the proper user(s) so that the list presentation 150 can add “battery” to the user's grocery or shopping list. In another embodiment, the system 100 can automatically communicate with merchant sources via fulfillment 170 to automatically place an order or purchase the battery using the user information from the user account 140. The address and payment information (e.g., credit card and billing information) for the user may already be stored in the system 100 so that when the user is identified, the product may be automatically ordered and/or purchased and shipped to the user.

Also as an alternative or addition, the product input device 110 may notify the system of the battery type that it is using (step 334). As discussed there may be a variety of different types of batteries that the product input device 110 may use. The product input device 110 may store information to keep track of what type of battery the user has used by communicating with the system 100. In some embodiments, because the user account 140 stores entries and information about items that have been scanned or added to a list by the user, the system 100 may monitor what types of batteries that the user has purchased, what time of battery the product input device 110 uses to operate, and determine the type of battery that needs to be ordered.

In other embodiments, as an alternative or addition, the product input device 110 may notify the system 100 that a new battery is needed and/or more batteries must be purchased by prompting the user or providing the user with various options and choices (step 336). For example, once the product input device 110 notifies the system 100 that batteries must be purchased, the user can be prompted on his or her computing device whether they want to purchase the battery. In other embodiments, all of the ordering may be performed by the system 100 so that the user is simply prompted whether or not to confirm the purchase. In this case, the user may press “OK” to confirm and the batteries will be automatically shipped to the user's home address. The user may also set preferences so that different prompts may be given when the system 100 is notified. For example, in some embodiments, the user may want to type in a password in order to verify the purchase or alter the shipping destination (e.g., work instead of home or the billing address) for receiving the batteries. The user may also decide which merchant or vendor to first attempt to purchase from. In other embodiments, the user may not want automatic purchasing or ordering, but instead may want to see “batteries” simply listed as one of his or her items on the grocery or shopping list so that he or she may purchase it the next time he or she goes to the store.

As an alternative, according to one or more embodiments, the system 100 may have a deal or agreement with one or more merchants or vendors so that the first battery order may be shipped for free, for example, and the user may easily enroll in a purchasing/ordering/shipping program with the vendor. For example, the vendor may provide a package with a UPC or other code that may be scanned by the product input device 110, so that when it is scanned by the user, the code automatically enrolls the user in future battery deliveries from that vendor. In other embodiments, the batteries could be shipped for free from a vendor perpetually and the costs may be included in the cost of goods sold. Among many benefits, the user does not have to manually monitor the battery levels or check the battery level of the disposable battery, and does not have order the batteries when the batteries are already dead (e.g., cannot use the device).

Although FIG. 3 has been described with respect to ordering batteries for the product input device, the product input device can monitor the operation of or detect problems, for example, of its other components and notify the system of other information about the product input device. The product input device can wirelessly provide to the server and/or the user's mobile computing device, information about the product input device, such as its battery level, its current state (e.g., whether there are any malfunctions, whether the device is being charged, etc.), the firmware or software versions, etc. The product input device can provide its information, for example, in response to detecting problems to other components of the device (e.g., so that the user can reorder components or order a new device), in response to a user query or selection of a feature via the mobile computing device, or in response to a set schedule (e.g., every week, or every month) configured by the user of the product input device.

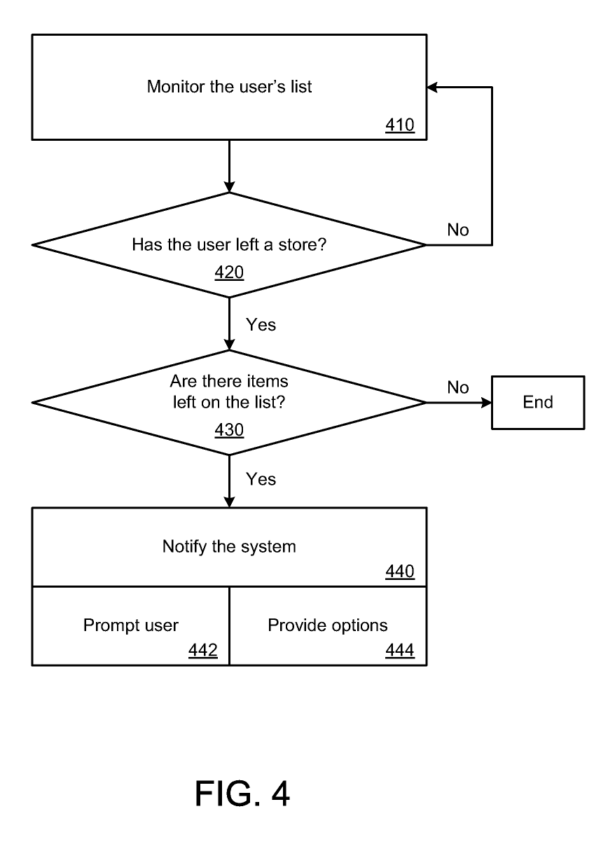

FIG. 4 illustrates a method for providing fulfillment offers for a user, under an embodiment. Often times, consumers go to a store or supermarket and do not find every item on their grocery or shopping list. This forces the typical consumer to make multiple trips to the store, or multiple stops at different stores that carry the item(s) that the user could not purchase initially. In other situations, some items are only available at certain stores or over the Internet (e.g., at a far away distance or only sold online), so that the user is unable to purchase everything on the list when he or she goes to the grocery store. In some embodiments, system 100 assists the user in fulfilling the user's needs by resolving such issues.

In FIG. 4, the system monitor's the user's shopping or grocery list (step 410). As discuss with respect to FIG. 1, the system 100 includes the user account 140 that communicates with the list presentation 150. The system 100 is able to keep track of items or products the user has added to his or her list. By monitoring changes made to the user's list (e.g., if the user deleted an item or a certain number of items, or marked off items as being purchased or placed items in a shopping cart), the system 100 may determine whether the user has gone to a store or a supermarket to go shopping.

According to one or more embodiments, the system 100 determines whether the user has gone to a store, finished at the store, and/or left the store (step 420). The system 100 may do this by determining if a user has placed items from the grocery or shopping list into another portion of the list, such as a “shopping cart,” to represent that these items have been found and purchased. Once the user clears the “shopping cart” via the user interface feature on his or her computing device, the system 100 determines that the user has finished shopping at the store. In another embodiment, the system 100 can determine if the user has finished or left the store by receiving location data from the user's mobile computing device. For example, the mobile computing device may include location aware mechanisms, such as GPS, to detect the current location of the mobile computing device (and therefore, the user). The mobile computing device may communicate this location information wirelessly to the system 100 via the connectors (see FIG. 1). In one embodiment, the mobile computing device may have software that detects whether the current location of the mobile computing device and the movement of the mobile computing device. The mobile computing device may determine whether it is at a location corresponding to a store or supermarket and detect that the user is leaving the store (e.g., using map data and databases, and location resources). This information may be transmitted to the system 100 so that the system 100 may determine that the user has left a store.

In an alternative embodiment, the system 100 includes geo-aware resources that communicate with location aware detection mechanisms of a mobile computing device of a user to determine the location of the user. In this manner, the system 100 may determine that the current location of the user is at a store or supermarket and can detect that the user is also leaving the store.

If the system 100 determines that the user has not left the store, it continued to monitor the user's grocery or shopping list (step 410). If the system 100 determines that the user has left the store, it determines whether there are items or products still left on the user's grocery or shopping list (step 430). By monitoring the user's list, the system 100 can determine the number of items and the particular items or products that have not yet been purchased (or marked as purchased) by the user. If there are no items left on the list, the process ends. If the system 100 determines that there are items left on the user's shopping list, the system 100 is notified that there are items left (step 440).

The system 100 may then offer to fulfill these items for the user. In one embodiment, the system 100 may prompt the user that there are items left (step 442). This may be important in case the user simply forgot to purchase an item that he or she could actually purchase at the current store that he or she is in. As an alternative or addition, the system 100 may also provide fulfillment options for the user (step 444). The system 100 may detect which items are on still on the user's shopping list and determine if another store or vendor has the available product. For example, the system 100 may provide the user with an option of a nearby store (e.g., by communicating with geo-aware resources and/or the location aware mechanism of the computing device) that has the product available for purchase. In other embodiments, the system 100 fulfills the user's needs by providing purchasing options for the item or product from a vendor over the Internet. The user may be provided with options of confirming the purchase, choosing when to purchase and/or deliver, or have the products or items ready for pickup. As discussed above, the system 100 may automatically place an order and have the user simply type in a password or press an “OK” soft button on the user interface of the computing device to purchase the product and ship it to the user's home or other location.

In an alternative embodiment, a user may purchase products or items at store by using near field communication (NFC) on his or her mobile computing device. The system 100 may detect whether the user has finished shopping or has left the store by communicating with the user's mobile computing device and determining that the purchase was made using NFC.

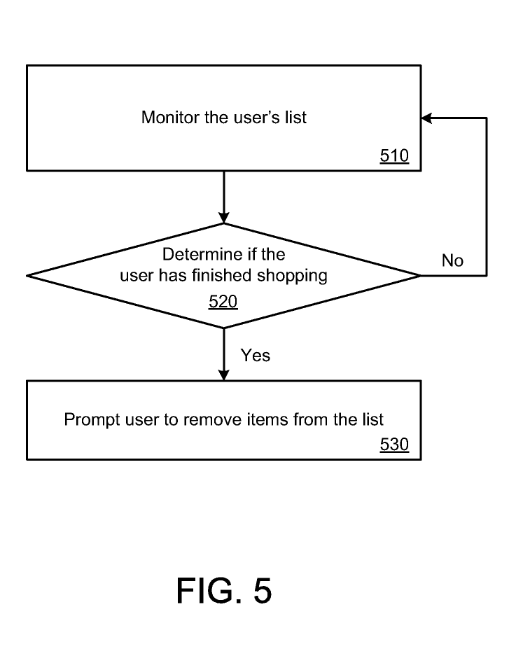

FIG. 5 illustrates a method for alerting a user to modify or organize a list, under an embodiment. Similar to FIG. 4, the system 100 monitors the user's shopping list (step 510). By monitoring the changes the user is making on the user's shopping list (e.g., marking an item as being purchased by placing in a “shopping cart”), the system 100 may determine if the user has finished shopping at a current store or location (step 520). The system 100 may make this determination by determining if a user has marked or has placed items from the grocery or shopping list into a “shopping cart,” to represent that these items have been found and purchased, and by using location information of the user's mobile computing device (e.g., such as described in FIG. 4) to determine if the user has left the vicinity of the store.

Upon determining that the user has finished shopping, the system 100 may automatically prompt or notify the user to remove items from the user's shopping list or to remove items from the shopping cart (step 530). Because users sometimes forget to update his or her shopping lists when they have finished shopping, the system 100 may assist the user in providing a more efficient and enhanced shopping experience.

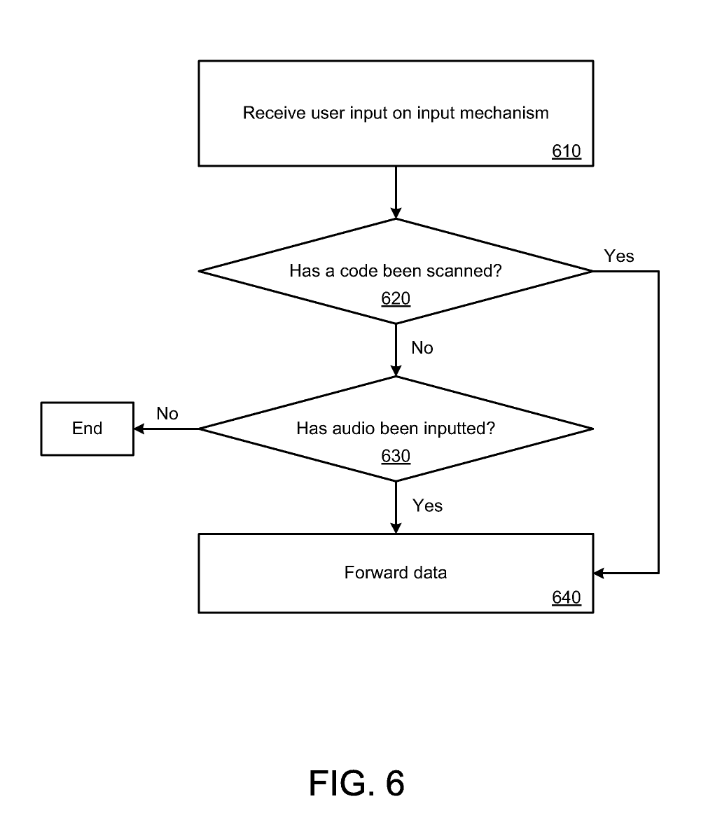

FIG. 6 illustrates a method for capturing data using a product input device, according to one or more embodiments. In some embodiments, the product input device 110 is a small device (e.g., a handheld device) having a minimal amount of components (to minimize production costs and for making the device cheaper for purchase). The product input device 110 may include just a single user input interface, such as one button. The single button may be used by the user to initiate the scan and/or to activate the microphone to record audio. The user only has to perform a single user action that captures all input, whether it is a scan of a code or audio input, so that the user does not have to explicitly choose which inputted data needs to be processed (e.g., added to the user's list or the user's account). Among many benefits, this creates an easy to use system with no typing necessary.

According to one or more embodiments, the user performs an action to initiate entry of data. The product input device 110 receives an initiation signal (e.g., in response to a user pressing the input mechanism of the product input device 110 or in response to other input triggers) (step 610). The input mechanism may be a single button, a small touch panel, a switch, etc., that is easy to access. By performing a single action via the input mechanism, the scanning device is activated to scan a code, such as a UPC, and a microphone is activated to record audio provided by a user. Depending on implementations, the microphone can be activated (and record audio input) for a duration of time the user holds down the button, touch panel, or switch, or contacts the device (e.g., for other triggering mechanisms). In another example, the microphone can be activated for a predetermined period of time after the initiation signal is provided. In this manner, a single button press by a user can activate the scanning device and the microphone of the product input device 110.

After receiving the user input, the product input device 110 determines whether a code has been scanned (step 620). If the product input device 110 determines that a code has been scanned, the product input device 110 forwards the data (step 640) to the system 100 (such as discussed with respect to FIG. 1).

If the code has not been scanned by the product input device 110, the product input device 110 determines if audio (e.g., audio having a sufficient decibel level so that the microphone can properly detect the audio) has been inputted via the microphone (step 630). If audio has not been inputted, then the process ends. However, if audio has been inputted, then the data is forwarded to the system 100 (step 640). As described, the audio can be transcribed (either on the device or on the server(s) depending on the embodiments) and provided on the user's shopping list.

In some embodiments, the determination steps 620, 630 may be performed concurrently. For example, the user may be speaking with someone while he or she is scanning a code using the button press of the input mechanism. In one embodiment, the product input device 110 prioritizes the different data it receives and forwards only the scanned code and disregards (or does not store) the audio data detected and/or recorded by the microphone (or vice versa). In other embodiments, both data is forwarded to the system 100 and the user may determine from the user interface feature on the computing device what data (e.g., the product ID, the UPC code if there is no product match, or the transcribed audio data) to keep or discard.

According to an embodiment, as discussed above with respect to FIGS. 1-6, some codes that are scanned or read by the product input device 110 may not necessarily be found in the product database 130. When the user scans the code, and no match is made, the system 100 may simply provide the scanned code (e.g., the numbers) on the user's shopping list and/or may provide a notification to the user that there was no match (e.g., vibrate or output a beep sound on a small speaker of the product input device, such as a sound of a buzzer for a wrong answer on a game show). The user may then provide an audio input a short predetermined time after so that the audio is transcribed and matched with the unknown code. This new transcribed audio can be stored in the product database 130 with the scanned code so that the product database 130 now contains an entry that matches the transcribed audio with the scanned code for future scanning purposes. In this manner, when the user scans the same code at a later time, a match can be made with the inputted transcribed audio.

In other embodiments, the user mechanism may be an accelerometer or gravitometer so that the product input device 110 can initiate the scanning device and/or the microphone when the user shakes the device or moves the device.

As an addition or an alternative, steps described in FIG. 6 can be performed on another computing device that is remote or separate from the product input device 110 (e.g., a server or another computing device). For example, once the product input device 110 scans a code and/or receives an audio signal, both the data corresponding to the detected product code and/or data corresponding to the detected audio signal can be transmitted or forwarded to a server. The server can then perform the determination of which data to include as an entry to the user's list or account (e.g., the server can perform steps 620, 630). The server can prioritize which data to use if both data corresponding to the detected product code and data corresponding to the detected audio signal has been transmitted to the server.

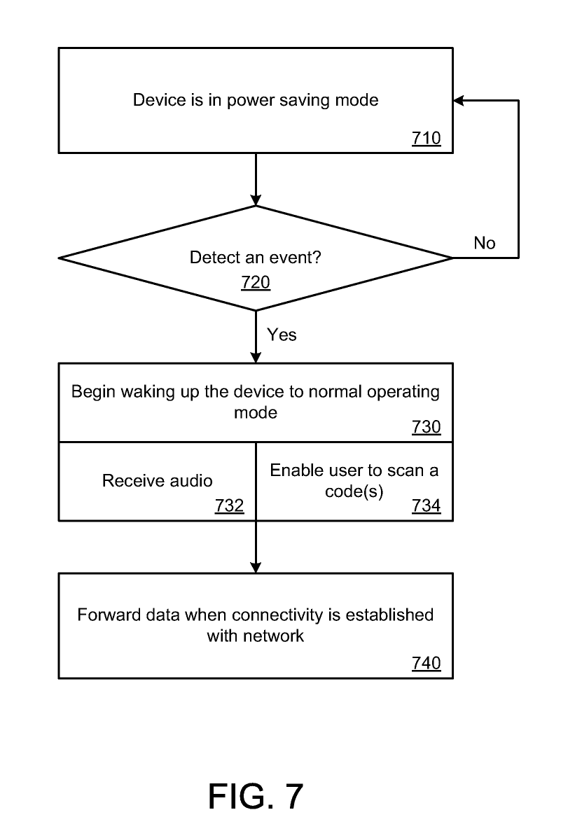

FIG. 7 illustrates a method for changing a state of a product input device, under an embodiment. In some embodiments, the product input device 110 may automatically change modes from an operating mode to a power saving mode (e.g., standby or sleep) so that its battery or power level is saved when it is not in use. The product input device 110 may switch states from power saving to normal operation in response to an event. The event may be related to some indication that the user wants to use the device.

For example, events may vary depending on different embodiments of the product input device 110. The event may be (i) the user holding the device so that proximity sensors provide an input to change states, (ii) the user holding the device so that an infrared (IR) sensor provide the input of a change in state, (iii) the user moving the device so that the accelerometer detects the movement and provides the input to wake up the device, (iv) the user speaking to the device in a sufficient decibel level and the microphone detects the audio to wake up the device, (v) the user pressing an input mechanism, such as a button, and (vi) other methods for changing the state.

In FIG. 7, the product input device 110 changes states from an operating mode into a power saving mode (step 710). The product input device 110 may be in the power saving mode after a predetermined amount of time the device is not being in use by the user. In some embodiments, when the product input device 110 is in the power saving or standby mode, different components of the product input device 110 may be shut down or turned off. For example, all radio components and processing components can be turned off or in a power saving state (lower operating state than normal) until the user needs to use the product input device 110. The product input device 110 will not be completely turned off, however, because components are necessary to be active in order to detect an event to wake up or change states into a normal operating mode.

The product input device 110, when it is in a power saving mode, will determine whether an event has occurred (step 720). If no event, such as an event described above, does occurs, the device is maintained in the power saving mode. However, if an event, such as the user pressing an input button to scan a code, occurs, the product input device 110 begins waking up to the normal operating mode (step 730). The product input device 110 will begin waking by up turning on components or waking up the components as quickly as possible. In some embodiments, certain components may wake up before other components, so that the product input device 110 may be able to perform certain tasks before others. In one embodiment, the scanning device or the microphone needs to be activated first because it enables the user to immediately scan or record audio as soon as the device begins waking up.

In some embodiments, while the product input device 110 begins waking up, the device may receive audio data (step 732) and/or enable the user to scan codes (step 734). Even if other components, such as the wireless (e.g., radio) communication component is not yet activated or awake, data can be received by the product input device 110. The product input device 110 may store the data in a memory resource and then forward the data when connectivity is established with the network (e.g., Wi-Fi component is in the normal operating state) (step 740). This enables the user to use the device without waiting for the device to fully be in a normal operating mode, thereby reducing the delay between waking up the device and using the device.

According to another embodiment, the product input device 110 periodically returns to a power saving mode quickly. In other embodiments, the product input device 110 changes states to a power save mode in a short time out, i.e., in a shorter predetermined amount of time after non-use by a user so that the components are shut down or in standby mode very quickly after the data capture (scanning the code or receiving an audio feed) is complete. This enables the battery life of the device to last as long as possible.

Hardware Diagram

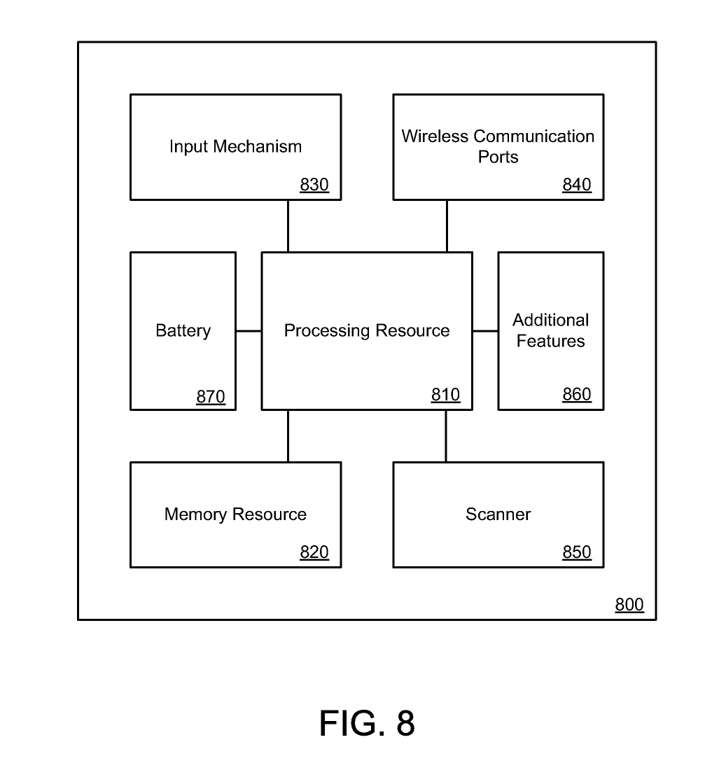

FIG. 8 illustrates a hardware diagram of a product input device upon which embodiments described herein may be implemented. For example, in the context of FIG. 1, the product input device 110 may be implemented using a system such as described by FIG. 8. According to an embodiment, device 800 includes a processing resource 810, memory resource 820, input mechanism 830, wireless communication ports 840, and scanning device 850 (e.g., a linear scanner or a laser scanner). Device 800 also includes a battery 870 (rechargeable or disposable) and additional features 860, such as a microphone, a speaker and/or light sources (e.g., LED) and/or accelerometers, proximity sensors or other sensing devices.

The processing resource 810 is coupled to the memory resource 820 in order to process information stored in the memory resource 820, perform tasks and functions, and run programs for operating the device 800. The memory resource 820 may include a dynamic storage device, such as random access memory (RAM), and/or include read only memory (ROM), and/or include other memory such as a hard drive (magnetic disk or optical disk). Memory resource 820 may store temporary variables or other intermediate information during execution of instructions (and programs or applications) to be executed by the processing resource 810. In some embodiments, as discussed above, memory resource 820 may store network setup data, data received from the scanning device and/or a microphone, and instructions for operating the device 800.

The device 800 includes an input mechanism 830 that is coupled to the processing resource 810 (and/or the scanning device 850 and/or the microphone—not shown in FIG. 8), for example, for enabling the user to use the device 800 by performing an action on the input mechanism 830 (e.g., a button press). Non-limiting, illustrative examples of input mechanism 830 include a touchpad, a small touch screen display, a button, or a switch.

Device 800 also includes communication ports 840 for communicating with other devices and/or networks. Communication ports 840 may include wireless communication ports for enabling wireless network connectivity with a wireless router, for example, or for cellular telephony capabilities. In some embodiments, communication ports 840 may also include IR, RF or Bluetooth communication capabilities, and may enable communication via different protocols (e.g., connectivity with other devices through use of the Wi-Fi protocol (e.g., IEEE 802.11(b) or (g) standards), Bluetooth protocol, etc.).

In some embodiments, the device 800 may include various securing features so that the device 800 may be easily hung or placed on certain locations where it would be easily used. For example, the device may include a clip, string, or magnetic retention features for sticking onto a surface of a refrigerator.

Embodiments described herein are related to the use of the device 800 for implementing the techniques described herein. According to one embodiment, the techniques are performed by the device 800 in response to the processing resource 810 executing one or more sequences of one or more instructions contained in the memory resource 820. Such instructions may be read into memory resource 820 from another machine-readable medium, such as an external hard drive or USB storage device. Execution of the sequences of instructions contained in memory resource 820 causes the processing resource 810 to perform the process steps described herein. In alternative embodiments, hard-wired circuitry may be used in place of or in combination with software instructions to implement embodiments described herein. Thus, embodiments described are not limited to any specific combination of hardware circuitry and software.

### Alternative Embodiments

One of the many benefits to the system 100 is that there is a guarantee that data will be received and placed on a user's list. The product input device 110 may notify the user if a code or audio has not been inputted via a sound produced from a speaker or from a colored blinking of a light, but the user will be able to see if a scanned item or transcribed audio data shows up on the user's list on his or her computing device. While many embodiments described herein relate to grocery or shopping lists, the system 100 may be used for other organization purposes, such as creating to-do lists or other types of lists.

Currently, there is no single source for all types of codes, such as UPC codes. This is because databases that keep track of codes and corresponding products exist for different types of manufacturers. For example, each manufacturer can create their own set of codes underneath their own manufacturer codes. In addition, some retailers label their own items and the UPC codes may be unique to that particular retailer (e.g., Trader Joe's). In some embodiments, the system 100 may improve upon the product database 130 by comprehensively building up the database through user input. For example, when the user scans a UPC code that does not have a match, the user may type in the corresponding product ID (“Doritos Cooler Ranch Chips”) on his or her device (or say the phrase via the microphone so that it is transcribed) in place of where the UPC code has been shown. This match can be stored by the system 100 in the product database 130 so that when the user scans the same item at a later time, a match can be made with the corresponding product ID previously entered by the user.

In another embodiment, a verification method can be performed by matching the UPC code and the product manually identified by a number of different users (using different product input devices) to determine if the match is correct. The higher the number of users represents a more accurate matching so that if a predetermined level is met, the data is then stored as reliable data in the product database 130.

It is contemplated for embodiments described herein to extend to individual elements and concepts described herein, independently of other concepts, ideas or systems, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is being claimed is:

1. A method of capturing data using a product input device, the method being performed by one or more processors of the product input device and comprising:
receiving an initiation signal in response to a user action on the product input device;
in response to receiving the initiation signal, (i) activating a scanner and a microphone of the product input device, and (ii) making a determination that the scanner detected a product code or that the microphone detected an audio signal; and
based on the determination, wirelessly forwarding data corresponding to the detected product code or data corresponding to the detected audio signal to a computing device.

2. The method of claim 1, wherein the user action includes at least one of an actuation of an input mechanism, a movement of the product input device that causes an accelerometer to provide the initiation signal, or coming into close proximity to or contacting a proximity sensor of the product input device to cause the proximity sensor to provide the initiation signal.

3. The method of claim 1, wherein the product code includes at least one of a 1-dimensional code or a 2-dimensional code.

4. The method of claim 1, wherein making a determination that the scanner detected a product code or that the microphone detected an audio signal includes (i) determining that the scanner detected the product code and the microphone detected the audio signal concurrently, and (ii) prioritizing the detected product code as being the detected before the detected audio signal.

5. The method of claim 4, wherein wirelessly forwarding data includes forwarding data corresponding to the detected product code and not forwarding data corresponding to the detected audio signal.

6. A system comprising:
a product input device including an input mechanism, a wireless communication port, and a sensing device, the product input device enabling a user to input data via the sensing device in response to a user action on the input mechanism; and
a computing device configured to (i) wirelessly communicate with the product input device in order to receive the data, (ii) determine a product identifier based on the data, (iii) determine a user account corresponding to the product input device, and (iv) generate list data that includes the product identifier.

7. The system of claim 6, wherein the product input device further includes a microphone, the product input device enabling the user to input audio data via the microphone in response to the user action on the input mechanism.

8. The system of claim 6, wherein the sensing device is a barcode scanner and wherein the product input device is configured to detect a product code in response to the user action on the input mechanism.

9. The system of claim 8, wherein the product input device wirelessly transmits the data to the computing device in response to detecting the product code.

10. The system of claim 6, wherein the computing device is configured to determine the product identifier by searching one or more product databases using the received data in order to identify a corresponding product identifier.

11. The system of claim 6, further comprising:
a mobile computing device configured to wirelessly receive the list data from the computing device and provide a user interface feature based, at least in part, on the list data on a display of the computing device, the computing device corresponding to the user account.

12. The system of claim 11, wherein the computing device enables the user to interact with the user interface feature in order to edit, mark, or delete one or more product identifiers that is provided as part of the user interface feature.

13. The system of claim 12, wherein the computing device enables the user to order one or more items corresponding to one or more product identifiers for purchase from one or more vendors via interaction with the user interface feature.

14. The system of claim 6, wherein the computing device is configured to, in response to receiving the data from the product input device, communicate with one or more vendors to automatically place an order for an item corresponding to the data.

15. A product input device comprising:
an input mechanism;
a scanner;
a microphone; and
a processing resource coupled to the input mechanism, the scanner, and the microphone, the processing resource to:
receive an initiation signal in response to a user action on the input mechanism;
in response to receiving the initiation signal, (i) activate the scanner and the microphone, and (ii) make a determination that the scanner detected a product code or that the microphone detected an audio signal; and
based on the determination, wirelessly forward data corresponding to the detected product code or data corresponding to the detected audio signal to a computing device.
